(19) United States
(12) Patent Application Publication
(10) Pub. No.: US 2020/0325900 A1
(43) Pub. Date: Oct. 15, 2020

(54) External Rotor Electric Pump

(71) Applicant: Hanon Systems EFP Canada Ltd., Concord (CA)

(72) Inventor: Kyle D. MILLS, Etobicoke (CA)

(21) Appl. No.: 16/812,514

(22) Filed: Mar. 9, 2020

Related U.S. Application Data
(60) Provisional application No. 62/831,950, filed on Apr. 10, 2019.

(51) Int. Cl. F04D 13/06; F04D 29/40; F04D 29/043; H02K 1/02; H02K 1/27; H02K 7/14; H02K 21/22

(52) U.S. Cl. CPC F04D 13/06; F04D 29/406; F04D 29/043; H02K 21/22; H02K 1/2786; H02K 7/14; H02K 1/02

(57) ABSTRACT

A pump assembly that includes a housing, a stator, a driveshaft, an impeller and a rotor. The housing includes a hollow cylindrically-shaped central portion. The stator surrounds and is fixed to the central portion of the housing. The driveshaft extends through and is rotatably supported by the central portion of the housing. The impeller fixed for rotation with the driveshaft. The rotor includes a first portion fixed for rotation with the driveshaft and a second portion surrounding the stator. The rotor includes a plurality of circumferentially spaced apart ferrite magnets fixed to the second portion of the rotor.

### CROSS-REFERENCE TO RELATED APPLICATIONS

This application claims the benefit of U.S. Provisional Application No. 62/831,950, filed on Apr. 10, 2019. The entire disclosure of the above application is incorporated herein by reference.

### FIELD

The present disclosure relates to an electric pump including a motor with an external rotor.

### BACKGROUND

This section provides background information related to the present disclosure and is not necessarily prior art.

A motor assembly for a water pump, for example, may include a rotor, a stator, a driveshaft rotationally fixed to the rotor, and magnets attached to the rotor. In a conventional motor assembly, the stator is typically external to the rotor and the magnets may be rare earth magnets. Rare earth magnets produce strong magnetic fields, but are expensive and subject to extreme price fluctuation in material cost. Therefore, there is a need for a motor assembly that operates effectively and efficiently using less expensive magnets. The present disclosure provides a motor assembly that operates effectively and efficiently using less expensive magnets.

### SUMMARY

This section provides a general summary of the disclosure, and is not a comprehensive disclosure of its full scope or all of its features.

In one form, a pump assembly includes a housing, a stator, a driveshaft, an impeller and a rotor. The housing includes a hollow cylindrically-shaped central portion. The stator surrounds and is fixed to the central portion of the housing. The driveshaft extends through and is rotatably supported by the central portion of the housing. The impeller fixed for rotation with the driveshaft. The rotor includes a first portion fixed for rotation with the driveshaft and a second portion surrounding the stator. The rotor includes a plurality of circumferentially spaced apart ferrite magnets fixed to the second portion of the rotor.

In some configurations of the pump assembly of the above paragraph, the plurality ferrite magnets are positioned between the second portion of the rotor and the stator.

In some configurations of the pump assembly of any one or more of the above paragraphs, the plurality of ferrite magnets cooperate to form a circle having a diameter larger than a diameter of the stator.

In some configurations of the pump assembly of any one or more of the above paragraphs, the plurality of ferrite magnets extend a greater distance in an axial direction than the stator.

In some configurations of the pump assembly of any one or more of the above paragraphs, a thickness of the plurality of ferrite magnets is greater than a thickness of the rotor.

In some configurations of the pump assembly of any one or more of the above paragraphs, the plurality of ferrite magnets have an arcuate shape.

In some configurations of the pump assembly of any one or more of the above paragraphs, the central portion includes a radially outwardly extending annular land. The stator is positively located and seated on the annular land.

In some configurations of the pump assembly of any one or more of the above paragraphs, the first portion of the rotor is a hub. The driveshaft is press-fit within an opening of the hub.

In another form, a motor assembly includes a rotor, a driveshaft, a stator and a first magnet. The driveshaft extends at least partially through the rotor and is rotationally fixed to the rotor. The stator is disposed between the rotor and the driveshaft. The first magnet is attached to the rotor and causes the rotor and the driveshaft to rotate relative to the stator. The first magnet being made of a ferrite material.

In some configurations of the motor assembly of the above paragraph, a diameter of the rotor is larger than a diameter of the stator.

In some configurations of the motor assembly of any one or more of the above paragraphs, a plurality of second magnets are attached to the rotor and cause the rotor and the driveshaft to rotate relative to the stator. The plurality of second magnets are made of a ferrite material.

In some configurations of the motor assembly of any one or more of the above paragraphs, the first magnet and the plurality of second magnets are attached to and disposed around an inner cylindrical surface of the rotor.

In some configurations of the motor assembly of any one or more of the above paragraphs, the rotor defines a cavity that houses the driveshaft, the stator and the first magnet.

In some configurations of the motor assembly of any one or more of the above paragraphs, the first magnet at least partially wraps around the stator.

In some configurations of the motor assembly of any one or more of the above paragraphs, the first magnet extends a greater distance in an axial direction than the stator.

In some configurations of the motor assembly of any one or more of the above paragraphs, a thickness of the first magnet is greater than a thickness of the rotor.

In yet another form, the present disclosure provides a pump assembly that includes a housing, a stator, a driveshaft, an impeller, a rotor and a plurality of ferrite magnets. The housing includes a cylindrically-shaped central portion. The stator surrounds and being fixed to the central portion of the housing. The driveshaft extends through and being rotatably supported by the central portion of the housing. The impeller is fixed for rotation with the driveshaft. The rotor includes a cylindrical-shaped first portion and a hub-shaped second portion. The first portion fixed for rotation with the driveshaft and the second portion surrounds the stator. The plurality of ferrite magnets is fixed to an inner cylindrical surface of the second portion and cooperates with each other to form a circle having a diameter greater than a diameter of the stator.

In some configurations of the pump assembly of the above paragraph, the rotor defines a cavity that houses the driveshaft, the stator and the plurality of ferrite magnets, and at least partially houses the housing.

In some configurations of the pump assembly of any one or more of the above paragraphs, the plurality of ferrite magnets are arcuate.

In some configurations of the pump assembly of any one or more of the above paragraphs, the driveshaft is press-fit within an opening of the second portion.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a fragmentary perspective view of a motor assembly for a water pump according to the principles of the present disclosure; and

FIG. 2 is cross-sectional view of the motor assembly.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

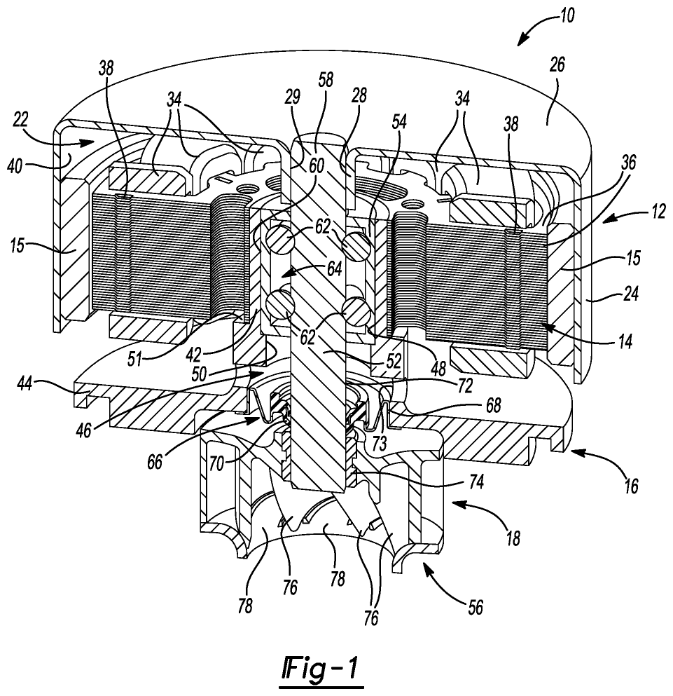

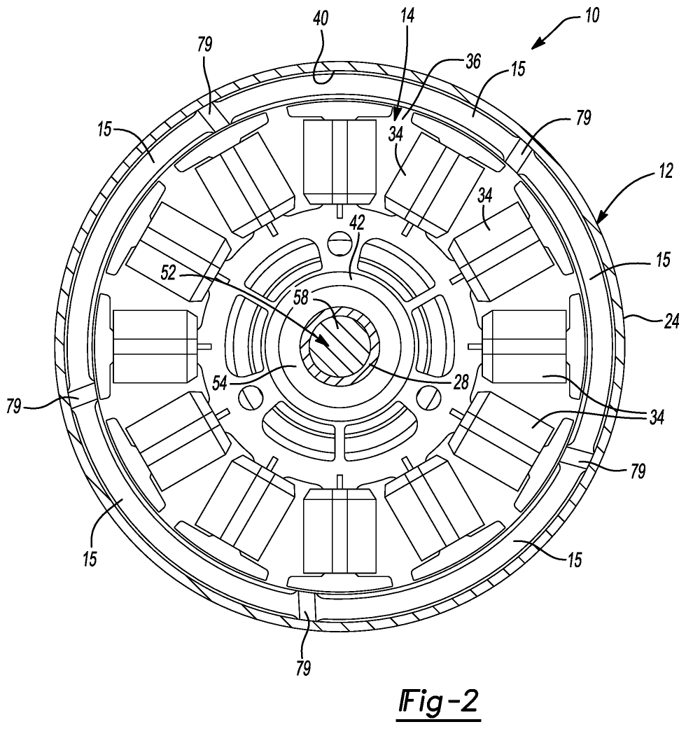

As shown in FIGS. 1 and 2, a motor assembly 10 is provided. The motor assembly 10 may be disposed within a water pump housing (not entirely shown) installed in a vehicle (not shown). The motor assembly 10 may include a rotor 12, a stator 14, a plurality of magnets 15 (e.g., ferrite magnets), a pump housing 16 and a driveshaft assembly 18. The rotor 12 may define a cavity 22 that houses the stator 14, the plurality of magnets 15, at least a portion of the pump housing 16 and a portion of the driveshaft assembly 18.

The rotor 12 may be made out of a metallic material and may be a generally cylindrical shape. The rotor 12 may include a cylindrical-shaped body 24, an end wall 26, and a hub portion 28. The hub portion 28 may extend from a middle portion of the end wall 26 into the cavity 22. The hub portion 28 may define an opening 29 that the driveshaft assembly 18 extends at least partially through.

The stator 14 may be fixed to the pump housing 16. For example, the stator 14 may be press-fit to the pump housing 16. The stator 14 may be disposed between the body 24 of the rotor 12 and the driveshaft assembly 18. The stator 14 may define a plurality of cavities that extend therethrough. A plurality of wire coils 34 may be attached to the stator 14. That is, each wire coil 34 extends through two of the cavities to attach to the stator 14. The stator 14 may include a laminated stack of plates 36. The plates 36 may be made of a metallic material and may be attached to one another via interlocking members 38. In other configurations, the plates 36 could be attached to each other by fasteners (e.g., rivets, bolts, etc.) and/or welds instead of or in addition to the interlocking members 38.

Pump housing 16 may be made of a metallic material, for example. The pump housing 16 may be disposed between the stator 14 and the driveshaft assembly 18. Pump housing 16 may include a cylindrically-shaped central portion 42 and a peripheral portion 44. The central portion 42 may be rotationally fixed to the stator 14 and may include a stepped opening 46. The stepped opening 46 may include an inner cylindrical surface 48 and a smaller diameter cylindrical surface 50. The peripheral portion 44 may extend radially outwardly from an end of the central portion 42. Central portion 42 includes a radially outwardly extending annular land 51. Stator 14 is positively located and seated on the annular land 51.

The driveshaft assembly 18 may include a driveshaft 52 and an impeller 56. The driveshaft 52 may extend at least partially through the opening 29 of the hub portion 28. The driveshaft 52 may be rotationally fixed to the hub portion 28 of the rotor 12 such that rotation of the rotor 12 causes corresponding rotation of the driveshaft 52. For example, an end 58 of the driveshaft 52 may be press-fit within the opening 29 of the hub portion 28.

A bearing housing 54 may be rotationally fixed to the central portion 42 of the pump housing 16. For example, the bearing housing 54 may be press-fit into the opening 46 such that an outer cylindrical surface 60 of the bearing housing 54 contacts the inner cylindrical surface 48 of the opening 46. In this way, the driveshaft 52 rotates relative to the bearing housing 54. Bearings 62 (e.g., ball bearings, tapered roller bearings, etc.), may be disposed within a cavity 64 formed between the bearing housing 54 and the driveshaft 52. The bearing housing 54 may act as an outer race for the bearings 62 and the driveshaft 52 may act an inner race for the bearings 62. The bearings 62 may rotate relative to the bearing housing 54 and the driveshaft 52.

An annular-shaped sealing member 66 may be made of a resiliently compressible material and may be rotationally fixed to the pump housing 16. For example, the sealing member 66 may be press-fit into the opening 46 such that an outer diametrical surface 68 of the sealing member 66 sealingly engages a cylindrical surface 73 of the stepped opening 46 and a lip 70 of the sealing member 66 sealingly engages a cylindrical surface 72 of the driveshaft 52. In this way, the driveshaft 52 rotates relative to the sealing member 66 and fluid circulating through the water pump (not shown) is prevented from reaching the bearing housing 54, the stator 14, the rotor 12, the magnets 15 and the wire coils 34, for example.

The impeller 56 is rotationally fixed to the other end of the driveshaft 52 via a retainer clip 74 such that rotation of the driveshaft 52 causes corresponding rotation of the impeller 56. It should be understood that, in some configurations, the impeller 56 may be press-fit to the driveshaft 52 as opposed to being rotationally fixed to the driveshaft 52 via the retainer clip 74. The impeller 56 may include a plurality of blades 76 that divide the impeller 56 into a plurality of regions 78. The impeller 56 may be at least partially housed in the water pump housing (not shown). In this way, fluid may flow into the regions 78 via an inlet (not shown) of the water pump housing. Rotation of the rotor 12, the driveshaft 52 and the impeller 56 causes fluid in the regions 78 to become pressurized. The pressurized fluid may be discharged from the water pump housing via an outlet (not shown).

Each magnet 15 may at least partially wrap around the stator 14 and may be disposed around and attached to an inner cylindrical surface 40 of the body 24 of the rotor 12. The magnets 15 may cooperate with each other to form a circle having a diameter that is larger than a diameter of the stator 14. The magnets 15 may have an arcuate shape and may extend a greater distance in an axial direction than the stator 14. The thickness of the magnets 15 may be greater than a thickness of the rotor 12.

Magnets 15 may be constructed from ferrite or another material that is substantially less expensive than rare earth magnet materials such as neodymium. Each magnet 15 may be attached to the inner cylindrical surface 40 of the body 24 by an adhesive (e.g., glue) or any other suitable method. A gap 79 may exists between adjacent magnets 15. In some configurations, another gap may also exist between each magnet 15 and the stator 14. When the stator 14 is energized, electrical current through the wire coils 34 generates a magnetic field. The magnetic field generated by the stator 14 and the wire coils 34 urges the magnets to move, which, in turn, causes the rotor 12 to rotate relative to the stator 14.

The motor assembly 10 of the present disclosure provides the benefit of having the rotor 12 external to the stator 14, which allows the rotor 12 to have an increased diameter relative to the stator 14, for example. The increased diameter provides for greater torque when the rotor 12 is rotating. This allows for the magnets 15 attached to the rotor 12 and causing the rotor 12 to rotate to be inexpensive and possibly larger in size than typical magnets while still allowing the water pump to be effective and efficient.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A pump assembly comprising:
a housing including a hollow cylindrically-shaped central portion;
a stator surrounding and being fixed to the central portion of the housing;
a driveshaft extending through and being rotatably supported by the central portion of the housing;
an impeller fixed for rotation with the driveshaft; and
a rotor including a first portion fixed for rotation with the driveshaft and a second portion surrounding the stator, the rotor including a plurality of circumferentially spaced apart ferrite magnets fixed to the second portion of the rotor.

2. The pump assembly of claim 1, wherein the plurality ferrite magnets are positioned between the second portion of the rotor and the stator.

3. The pump assembly of claim 1, wherein the plurality of ferrite magnets cooperate to form a circle having a diameter larger than a diameter of the stator.

4. The pump assembly of claim 1, wherein the plurality of ferrite magnets extend a greater distance in an axial direction than the stator.

5. The pump assembly of claim 1, wherein a thickness of one of the plurality of ferrite magnets is greater than a thickness of the rotor.

6. The pump assembly of claim 1, wherein each magnet of the plurality of ferrite magnets has an arcuate shape.

7. The pump assembly of claim 1, wherein the central portion includes a radially outwardly extending annular land, and wherein the stator is positively located and seated on the annular land.

8. The pump assembly of claim 1, wherein the first portion of the rotor is a hub, and wherein the driveshaft is press-fit within an opening of the hub.

9. A motor assembly for a water pump, the motor assembly comprising:
a rotor;
a driveshaft fixed for rotation with the rotor;
a stator disposed between the rotor and the driveshaft, the stator including a wire coil; and
a first magnet attached to the rotor and being made of a ferrite material, wherein electrical energization of the wire coil causes the rotor and the driveshaft to rotate relative to the stator.

10. The motor assembly of claim 9, wherein a diameter of the rotor is larger than a diameter of the stator.

11. The motor assembly of claim 9, further comprising a plurality of second magnets attached to the rotor, wherein the plurality of second magnets are made of a ferrite material.

12. The motor assembly of claim 11, wherein the first magnet and the plurality of second magnets are attached to and disposed around an inner cylindrical surface of the rotor.

13. The motor assembly of claim 9, wherein the rotor defines a cavity that houses the driveshaft, the stator and the first magnet.

14. The motor assembly of claim 9, wherein the first magnet at least partially wraps around the stator.

15. The motor assembly of claim 9, wherein the first magnet extends a greater distance in an axial direction than the stator.

16. The motor assembly of claim 9, wherein a thickness of the first magnet is greater than a thickness of the rotor.

17. A pump assembly comprising:
a housing including a cylindrically-shaped central portion;
a stator surrounding and being fixed to the central portion of the housing;
a driveshaft extending through and being rotatably supported by the central portion of the housing;
an impeller fixed for rotation with the driveshaft;
a rotor including a cylindrically-shaped first portion and a hub-shaped second portion, the first portion fixed for rotation with the driveshaft and the second portion surrounding the stator; and
a plurality of ferrite magnets fixed to an inner cylindrical surface of the second portion and arranged relative to each other to form a circle having a diameter greater than a diameter of the stator.

18. The pump assembly of claim 17, wherein the rotor defines a cavity that houses the driveshaft, the stator and the plurality of ferrite magnets, and at least partially houses the housing.

19. The pump assembly of claim 17, wherein each one of the plurality of ferrite magnets are arcuate.

20. The pump assembly of claim 17, wherein the driveshaft is press-fit within an opening of the second portion.
